(19) United States
(12) Patent Application Publication
(10) Pub. No.: US 2011/0308900 A1
(43) Pub. Date: Dec. 22, 2011

(54) BRAKE SYSTEM FOR DISK BRAKES

(76) Inventor: Olaf Drewes, Aschaffenburg (DE)

(21) Appl. No.: 13/119,853

(22) PCT Filed: Nov. 13, 2009
(86) PCT No.: PCT/EP09/65142

§ 371 Date: Jun. 8, 2011

(30) Foreign Application Priority Data
Nov. 25, 2008 (DE) 10 2008 044 060.4

(51) Int. Cl. F16D 65/095; F16D 55/22

(52) U.S. Cl. 188/73.37

(57) ABSTRACT

A brake system for disk brakes, particularly of land vehicles, including a brake caliper including two opposite brake linings adapted to engage with a brake disk arranged between the brake linings, and a brake bracket on which the brake caliper is arranged in an axially movable manner by a fastening device, wherein the fastening device includes a first bearing device through which the brake caliper is supported on the brake bracket in a vibration-damped manner, the brake caliper is supported on the brake bracket by a damping element that includes a hydro-bearing of the first bearing device, fastening device includes a second bearing device that supports the brake caliper on the brake bracket in an axially movable manner, and wherein the bearing device includes a vibration-damped fixed bearing.

### BACKGROUND OF THE INVENTION

The present invention relates to a brake system for disk brakes, particularly of land vehicles, designed of a brake caliper straddling the brake disk and a brake carrier carrying the brake caliper.

Brake systems of the type in question are well-known from the prior art. Thus, brake systems have been developed in which, with a view to optimizing weight and costs, the ring carrier of the brake, which also accommodates the reaction-sided brake lining, has been replaced by a flat carrier in which the reaction-sided brake lining is supported directly in the brake caliper. However, the problem of such brake systems is that, due to the fact that the brake lining is directly supported in the brake caliper of the brake, vibrations, which are for example initiated directly in the brake caliper by the brake lining getting caught with the brake disk and subsequent unsnapping (so-called slip-stick effect). Consequently, sensitive parts, such as the braking cylinder, the connection of the brake caliper at the brake bracket or the connection of the chassis system at the vehicle (frame) can be damaged by these vibrations such that they fail. A further problem is that the development of noises of the brake system during the braking process due to vibrations is so great that it is not possible to use the brakes without generating undue noises. Finally, such a brake system compromises the operational safety of the vehicle during the braking process.

Therefore, it is an object of the present invention to provide a brake system for disk brakes, particularly of land vehicles, in which noises due to vibrations can be avoided, while optimizing the braking efficiency.

### SUMMARY OF THE INVENTION

According to the invention there is provided a brake system for disk brakes, particularly of land vehicles, comprising a brake caliper, which comprises two opposite brake linings in order to engage with a brake disk arranged between said brake linings, and a brake bracket, on which the brake caliper is arranged in an axially movable manner through a fastening device, wherein the fastening device comprises a first bearing device, through which the brake caliper is supported on the brake bracket in a vibration-damped manner. Expediently, the brake system is provided for disk brakes, wherein the brake disk of disk brakes can be designed solidly or as a ventilated brake disk. The brake system is used in particular in land vehicles, such as motor vehicles, commercial vehicles, trailers or trains, however, it can be provided in any other machine or vehicle (airplane) employing a brake or brake system. Expediently, in order to brake the brake disk, the brake caliper has two opposite brake linings. To put it differently, the brake linings are arranged opposite each other in the axial direction such that the brake disk is arranged between the brake linings. In this context, the axial direction is a direction essentially perpendicular to the plane of rotation of the brake disk so that the axial direction is arranged essentially parallel to the axis of rotation of the wheel or the brake disk or corresponds to said axis of rotation, respectively. Advantageously, the brake bracket is provided so as to accommodate the brake caliper through a fastening device such that the brake caliper is axially movable relative to the brake bracket. To put it differently, the brake caliper can be moved in the axial direction relative to the brake bracket. Thus, the brake caliper is expediently designed in the form of a so-called floating caliper which is arranged in an axially movable manner on the brake bracket such that the latter presses the opposite (not movable) brake lining towards the brake disk by means of a caliper wrap-around (pliers-like) when the braking cylinder is activated. Consequently, the braking cylinder and the brake piston are provided only on one side of the brake disk on the brake caliper. In order to transmit the braking power to the brake disk, the brake bracket is arranged on the vehicle in an unrotatable manner. Advantageously, this is done by means of an indirect attachment (via intermediary elements) or by means of a direct attachment of the brake bracket on a chassis or frame element of the vehicle. Advantageously, the brake caliper is arranged or attached or supported on the brake bracket via a fastening device. To this end, the fastening device expediently has a first bearing device, by means to which the brake caliper is supported on the brake bracket in an at least partially vibration-damped manner. To put it differently, the first bearing device makes it possible that vibrations of the brake caliper in this area are not at all or only to a small extent transmitted into the brake bracket. Thus, the first bearing device essentially can be designed as a loose bearing which provides so much clearance between the bearing elements of the first bearing device that the vibrations occurring in the brake caliper are not at all or only to a small extent passed on into the brake bracket. In order to improve the operational safety of the brake system according to the invention, thus, the damping, which originally was intended in a temperature-critical area close to the brake lining, i.e. the support of the brake caliper on the brake bracket, can be relocated.

Advantageously, the brake caliper is supported on the brake bracket by means of a damping element of the first bearing device. Thus, the first bearing device has a damping element which makes it possible that vibrational energy which is initiated by the brake caliper into the first bearing devices is absorbed and not passed on to the brake bracket. As a matter of course, the damping element can also be designed as a damping unit having a plurality of damping elements arranged therein.

Advantageously, the first bearing device has a first bearing pin and a first accommodation, the one being provided on the brake bracket and the other on the brake caliper, wherein the first bearing pin is at least partially accommodated in the first accommodation. The accommodation can be provided in the brake bracket. Preferably, however, it is arranged in the brake caliper. Likewise, the first bearing pin can be provided in the brake caliper, however, particularly preferably it is arranged on the brake bracket. It has been shown that both alternatives are of equal value and effect. Expediently, the first bearing pin is designed essentially cylindrical and advantageously extends essentially in the axial direction. The shape and the cross-section (essentially perpendicular to the axial direction) of the first bearing pin can be as needed. It is particularly preferred that the first bearing pin has a round, particularly preferably a circular cross-section. The first bearing pin can be formed hollow or solid and can be made either as a single piece from a single element or multi-piece. Particularly expediently, the first bearing pin is formed multi-piece, i.e. from a jacket or sleeve through which a screw or bolt extends which fastens or attaches the jacket or sleeve on the brake bracket. In this case, the jacket or sleeve thus serves as bearing element surface of the first bearing pin. The first accommodation is designed such that the first bearing pin can extend axially into said accommodation. To this end, the first accommodation is thus essentially designed as a recess or cavity surrounding the first bearing pin at least partially. In order to allow for the axial movability of the brake caliper, the first bearing pin can move in the axial direction in the first accommodation.

Expediently, the first bearing pin and the first accommodation are connected to one another by means of a damping element. To put it differently, the damping element is the connecting member between the first bearing pin and the first accommodation. To this end, the damping element advantageously is arranged between the first bearing pin and the first accommodation. To put it differently, the damping element thus can be accommodated or arranged or provided in the first accommodation. As regards the first bearing pin, the damping element is arranged around it or is arranged circumferentially or encloses a ring-shaped area of the surface area of the first bearing pin or is arranged on the same.

Advantageously, the damping element is designed as a ring-shaped body. Thus, it is particularly expedient that the damping element is formed as a hollow cylinder. Here, the first bearing pin can extend through the damping element, and the first accommodation can be arranged on the outer surface or surface area of the damping element.

Preferably, the damping element has a non-constant or non-linear spring characteristics or damper characteristics. The spring characteristics or spring constant or spring stiffness is defined by the relationship between deformation of the damping element and the force exerted on said damping element. The spring characteristics or damper characteristics can be non-constant or non-linear. As a result, the so-called “slip-stick effect” is particularly advantageously reduced, which effect occurs when the brake pressure or force exerted on the brake is small so that the brake caliper starts to vibrate with its natural frequency or a multiple thereof. Accordingly, the spring characteristics or damper characteristics is shaped relatively flat in a first region. If there is a high brake pressure or if a great force is exerted, there are no vibrations so that there is less necessity of damping. Rather, the brake caliper should be optimally guided in the case of a high brake pressure. Therefore, the spring characteristics or damper characteristics is shaped steep or steeper in this region.

In a preferred embodiment, the damping element is designed as an elastomer bearing the elastomer core of which preferably has a Shore A hardness of about 35 to about 90. The elastomer core or the elastomer element, respectively, of the damping element can be designed of any material, however, it is preferably designed of a rubber. Preferably, the elastomer core has a Shore A hardness of about 35 to about 90, particularly preferably of about 45 to about 80 and very particularly preferably of about 55 to about 75.

Advantageously the damping element designed as elastomer bearing is made up of several layers and preferably has an outer soft region and an inner hard region. In the radial direction or in a cross-section perpendicular to the longitudinal axis of the damping element, the damping element has at least two radially or concentrically arranged layers. Thus, the outer region or the outer surface area, respectively, can be made of a softer material than the inner region or the inner surface area, respectively. Expediently, the multi-layer damping element in its outer region has a Shore A hardness of 35 to 50, particularly preferably of about 40 to 45 and the inner region has a Shore A hardness of about 50 to 90, preferably of about 60-75. Alternatively or additionally the elastomer bearing can have material cavities in its outer region so as to define a softer region.

In an alternative embodiment, the damping element can be designed as a hydro-bearing which preferably is designed as a ring-shaped hollow body in the interior of which a fluid is provided. Here, in particular a fluid, such as oil, serves for damping purposes.

Furthermore, the cavity of the hydro-bearing can be divided into individual chambers which are connected to one another. The fluid, which is contained therein, can flow through this connection so that the relative movements between the two connecting members of the bearing are directly transferred to the enclosed fluid and lead to a relative enlargement or minimization of the main chambers for the flow of the fluid.

Expediently, the hydro-bearing comprises a fluid the viscosity of which preferably can be changed or adjusted by means of a control device. Thus, the viscosity or flow properties, respectively, of the fluid can be controlled depending on the situation. Thus, particularly advantageously, a rheological liquid can be provided the viscosity or toughness of which can be adjusted or controlled or determined, respectively. In order to change or adjust the viscosity of the fluid, a control device can be provided. Said device can be such that an electric and/or magnetic field and/or an electric current or voltage, respectively, is introduced into the fluid such that said fluid changes its viscosity properties. Thus, in contrast to a multi-layer elastomer bearing, the hydro-bearing makes it possible to provide not only a linear spring characteristics or damper characteristics but a non-constant or non-linear and freely adjustable spring characteristic diagram or damper characteristic diagram.

As a matter of course, it is also possible to provide a combination of different damping systems as damping element, such as the combination of an elastomer bearing and a hydro-bearing. It is equally possible to use an air bearing or the combination of such air bearing and an elastomer bearing.

Preferably, the fastening device has a second bearing device by means of which the brake caliper is supported on the brake bracket in an axially movable manner. As regards the axial movability, the second bearing device thus fulfills the same properties, requirements or prerequisites as the first bearing device.

In contrast to the first bearing device, it is expedient that the second bearing device is designed as a vibration-damped fixed bearing. The second bearing device is thus characterized in that between the bearing elements of the brake caliper and brake bracket there is no clearance at all or only very little clearance. As to the rest, no damping element is provided between the bearing elements of the second bearing device of brake caliper and brake bracket. As the first bearing device is designed as a vibration-damped loose bearing and the second bearing device is designed as a vibration-damped fixed bearing, there is thus advantageously provided a statically determined system, which makes it possible to prevent that during the braking process the brake caliper “flutters” undesirably. As a result, the braking efficiency or operational safety, respectively, of the brake system is further improved.

Preferably, the second bearing device has a second bearing pin and a second accommodation, one of which is provided on the brake bracket and the other one on the brake caliper, and wherein the second bearing pin is at least partially accommodated in the second accommodation. The accommodation can be provided in the brake bracket. Preferably, however, it is arranged in the brake caliper. Likewise, the second bearing pin can be provided in the brake caliper, however, it is particularly preferred that it is arranged on the brake bracket. It has been shown that both alternatives are of equal value and effect. The second bearing pin expediently is designed essentially cylindrical and advantageously essentially extends in the axial direction. The shape and the cross-section (essentially perpendicular to the axial direction) of the second bearing pin can be as needed. It is particularly preferred that the second bearing pin has a round, particularly preferably a circular cross-section. The second bearing pin can be formed hollow or solid and be made either as a single piece from a single element or multi-piece. Particularly expediently the second bearing pin is formed multi-piece, i.e. from a jacket or sleeve through which a screw or bolt extends, which fastens or attaches the jacket or sleeve on the brake bracket. In this case, the jacket or sleeve then serves as bearing element surface of the second bearing pin. The second accommodation is designed such that the second bearing pin can extend axially into said accommodation. To this end, the second accommodation is thus designed essentially as a recess or cavity surrounding the second bearing pin at least partially. In order to ensure the axial movability of the brake caliper, the second bearing pin can move in the second accommodation in the axial direction. Thus, the second bearing pin can be directly supported in the second accommodation in an axially movable manner. However, particularly preferably there is provided between the second bearing pin and the second accommodation a jacket which serves as a sliding bearing for an axial movability of the second bearing pin in the second accommodation. Particularly preferably, the jacket or sleeve has the same cross-sectional configuration (inner and outer diameters) as the damping element of the first bearing device.

Preferably, the first and second accommodations have the same inner configuration. To put it differently, the first and the second accommodations are identically designed with respect to their dimensions at least in the area in which they accommodate the first and the second bearing pins. It is further preferred that the first and the second bearing pins are identically designed at least as regards their cross-sectional configuration (diameter, cross-sectional shape, . . . ).

Further advantages and features of the present invention result from the following description of preferred, exemplary embodiments of the brake system according to the invention with reference to the appended figures, wherein individual features of the individual embodiments can be combined to form new embodiments. The figures show:

### BRIEF DESCRIPTION OF THE DRAWINGS

FIG. 1 is a partial cross-sectional perspective view of an exemplary embodiment of the brake system according to the invention.

FIG. 2 is a further partial cross-sectional perspective view of an exemplary embodiment of the brake system according to the invention.

FIG. 3 is a partial cross-sectional view of a first preferred embodiment of the first bearing device according to the invention.

FIG. 4 is a partial cross-sectional view of a second preferred embodiment of the first bearing device according to the invention.

FIG. 5 is a partial cross-sectional view of a preferred embodiment of the second bearing device according to the invention.

FIGS. 6a and 6b are characteristic curves of damping elements made of an elastomer material according to preferred embodiments.

FIGS. 7a and 7b are characteristic diagrams of damping elements designed as hydro-bearings according to preferred embodiments.

### DETAILED DESCRIPTION OF THE PREFERRED EMBODIMENTS

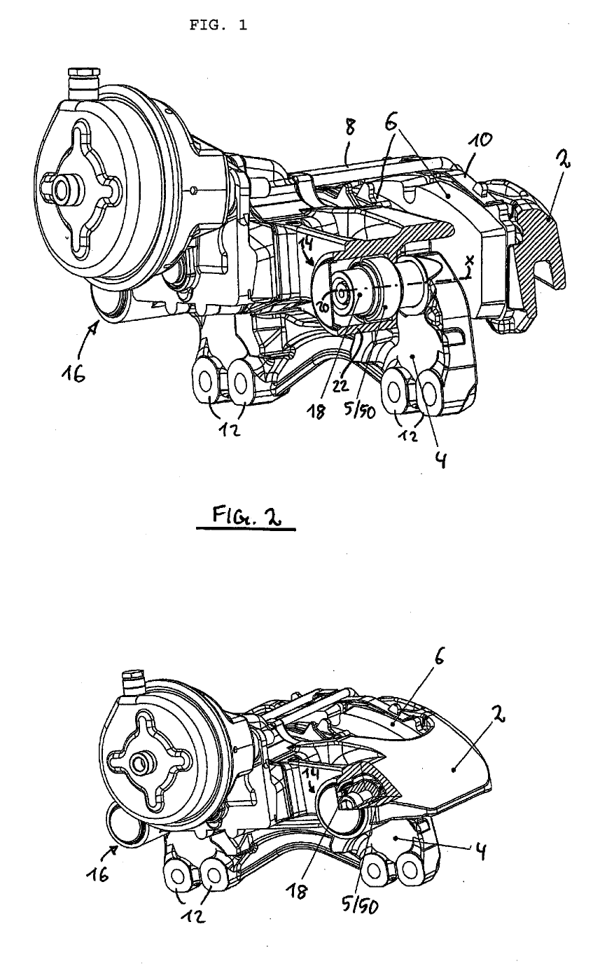

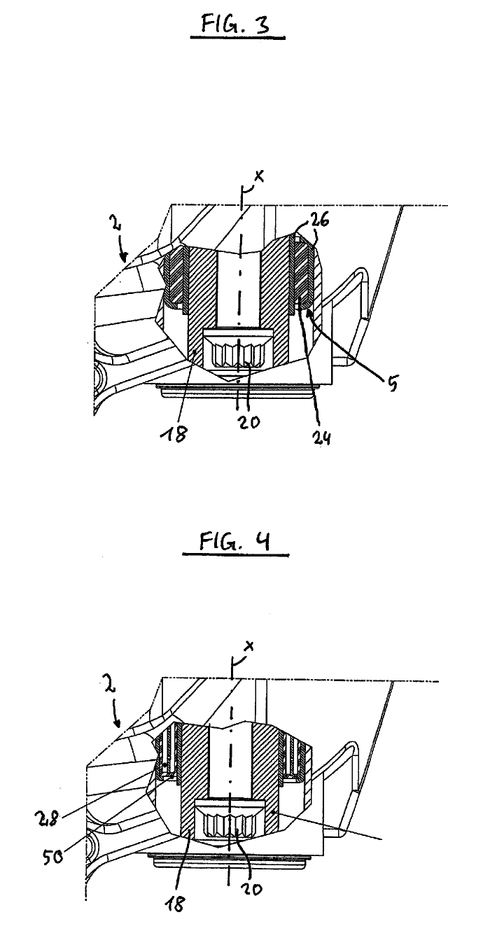

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1 and 2 show a perspective, partially cross-sectional view of a first preferred, exemplary embodiment of the brake system according to the invention. Said brake system comprises a brake caliper 2 as well as a brake bracket 4.

The brake caliper 2 is designed essentially O-shaped when viewed from above so as to accommodate a brake disk lying therein (not shown). The brake caliper 2 furthermore has two opposite brake linings 6 which are arranged along an axial direction x on each side of the brake disk so as to engage with the same. Here, the axial direction x essentially corresponds to the axis of rotation of the wheel or the brake disk, respectively or is essentially parallel to said axis. In order to prevent that the brake linings 6 slip out in the radial direction, they are fixed towards the top by means of a retaining bracket 8 and pre-tensioned by means of spring clips 10. Furthermore, the brake caliper has a brake piston and a braking cylinders (shown on the left-hand side in FIGS. 1 and 2), by means of which the brake lining 6 adjacent thereto can be slid in the direction of the opposite brake lining so as to actuate the brake disk lying therebetween. In order to make it possible that both brake linings 6 engage with the brake disk, the brake caliper forms part of a so-called floating caliper brake and, therefore, is arranged slidably or movably along the axial direction x.

The brake bracket 4 comprises a fastening section 12 by means of which the brake system is fastened indirectly or directly, in an essentially rigid manner, to the suspension system or frame of a vehicle. Furthermore, the brake bracket 4 has a first bearing device 14 and a second bearing device 16. The brake caliper 2 is arranged movably in the axial direction x on the brake bracket 4 by means of the first bearing device 14 and the second bearing device 16 so as to allow for the function of the floating caliper brake.

In order to not at all or only minimally transmit the vibrations occurring during the braking process to the brake bracket 4, the brake caliper 2 is supported on the brake bracket 4 by means of a damping element 5; 50 of the first bearing device 14. To this end, the first bearing device 14 has a first bearing pin 18 which, starting from the brake bracket 4, extends in the axial direction x. The first bearing pin 18 is fixed to the brake bracket 4 by means of a fastening means 20. A distal end region of the first bearing pin 18 extends into a first accommodation 22 of the brake caliper 2. The first accommodation 22 is designed as a cavity or recess, respectively, which extends in the axial direction x.

In order to allow for a damping of vibrations, the first bearing pin 18 and the first accommodation 22 are connected to one another by means of the damping element 5, 50. In the exemplary embodiment of the first bearing device 14 shown in FIG. 3, the damping element 5 is designed as an elastomer bearing. The latter has an elastomer core or a damping core 24, respectively, which extends in ring shape and concentrically around the first bearing pin. Towards the surface area of the first bearing pin 18 and towards the inner surface area of the first accommodation 22 the damping core 24 is protected by means of respective protective bodies 26.

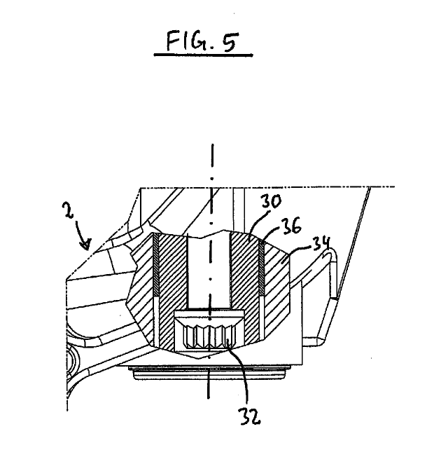

In the alternative exemplary embodiment shown in FIG. 4, the damping element 50 is designed as a hydro-bearing. The latter is designed as a ring-shaped hollow body inside of which oil or another fluid is provided so as to absorb vibrations. It is particularly advantageous that the hollow space 28 of the hydro-bearing 50 is divided into individual chambers. Advantageously, the fit between the damping element 5; 50 and the first accommodation 22 as well as the first bearing pin 18 is such that during the actuation of the brake the damping element 5; 50 remains essentially stationary relative to the first accommodation 22 while the first bearing pin 18 slides in the axial direction in the damping element 5; 50.

FIG. 5 shows a partial cross-sectional view of the second bearing device 16. Expediently, said bearing device is designed as a vibration-damped fixed bearing so that together with the vibration-damped first bearing device 14 a statically determined system is formed. Accordingly, the second bearing device 16 has a second bearing pin 30, which extends in the axial direction x and is fixed to the brake bracket 4 by means of fastening means 32. The second bearing pin is accommodated at least partially within a second accommodation 34 which can be designed equivalent to the first accommodation 22. The inner diameter of the second accommodation 34, however, does not have to be the same as that of the first accommodation 22, but can be adapted to the outer configuration of a jacket or sleeve 36 arranged between the second bearing pin 30 and the second accommodation 34, if necessary. Expediently, the jacket or sleeve 36 can be arranged as a sliding bearing with no clearance at all or only very little clearance between the second bearing pin 30 and the second accommodation 34.

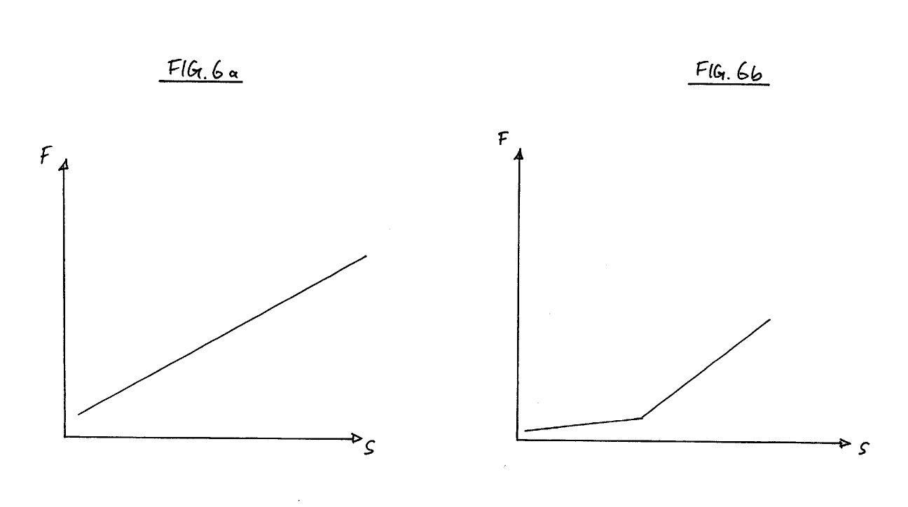

FIG. 6 shows characteristic curves of damping elements 5. FIG. 6a shows the characteristic curve of a damping element with a linear spring or damper characteristics, respectively. To put it differently, according to FIG. 6a, the damping element 5 is designed of an essentially homogenous material or of the same material, respectively. FIG. 6b shows a spring or damper characteristics of a preferred embodiment of the damping element 5. As can be seen, the spring curve is not constant or linear. This is in particular the case if an elastomer bearing is used which consists of several layers, wherein the outer region preferably is soft and the inner region is designed of a harder material.

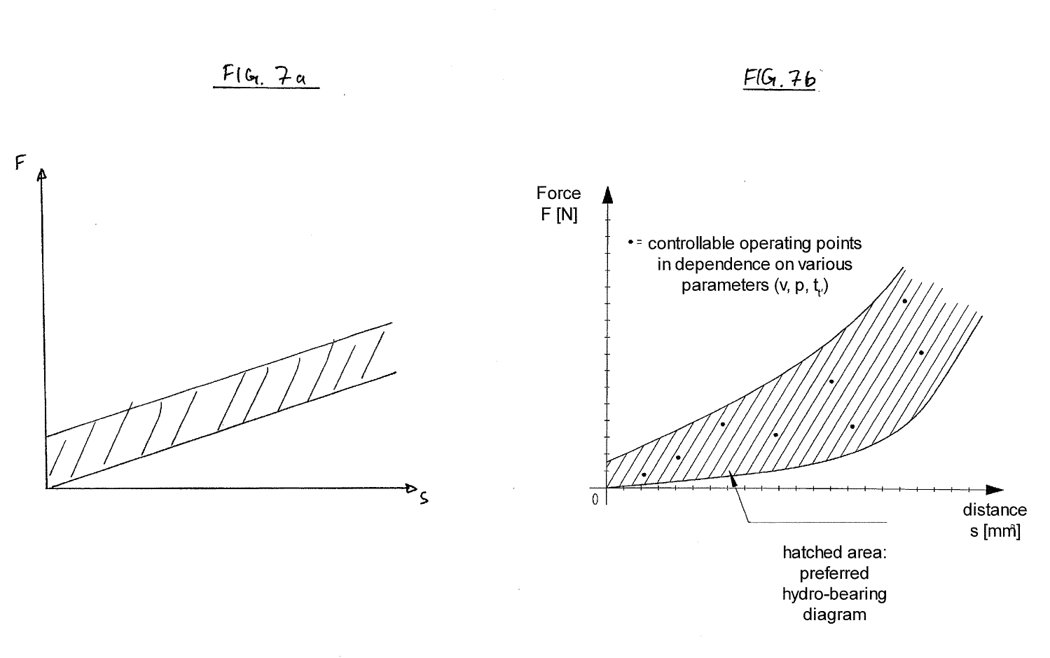

FIG. 7a shows a spring or damper characteristic diagram of a standardized hydro-bearing. As can be seen, the spring or damper characteristic diagram is essentially linear. In contrast, FIG. 7b shows a spring or damper characteristic diagram of a hydro-bearing, in which the viscosity of the fluid arranged therein can be varied or adjusted, respectively, by means of a control device.

The damping elements of the characteristic curves and diagrams, respectively, shown in FIGS. 6b and 7b offer the advantage that vibrations of the brake caliper can be optimally prevented in the case of a low brake pressure, wherein a lower degree of damping is provided in the case of a high brake pressure so that the brake caliper is optimally guided.

1-14. (canceled)

15. A brake system for disk brakes, comprising:
a brake caliper comprising two opposite brake linings adapted to engage with a brake disk arranged between the brake linings; and
a brake bracket on which the brake caliper is arranged in an axially movable manner by a fastening device;
wherein the fastening device comprises a first bearing device through which the brake caliper is supported on the brake bracket in a vibration-damped manner;
wherein the brake caliper is supported on the brake bracket by a damping element that includes a hydro-bearing of the first bearing device; and
wherein the fastening device comprises a second bearing device that supports the brake caliper on the brake bracket in an axially movable manner, and wherein the bearing device includes a vibration-damped fixed bearing.

16. The brake system according to claim 15, wherein the first bearing device comprises a first bearing pin and a first accommodation, wherein a select one of the first bearing pin and the first accommodation is supported on the brake bracket and the other is supported on the brake caliper; and
wherein the first bearing pin is at least partially accommodated in the first accommodation.

17. The brake system according to claim 16, wherein the first bearing pin and the first accommodation are connected to one another by a damping element.

18. The brake system according to claim 17, wherein the damping element includes a ring-shaped body.

19. The brake system according to claim 18, wherein the damping element has at least a select one of a non-constant spring and non-constant damper characteristic.

20. The brake system according to claim 19, wherein the damping element comprises an elastomer bearing including an elastomer core having a Shore A hardness of about 35 to about 90.

21. A brake system according to claim 19, wherein the damping element comprises an elastomer bearing that includes multiple layers, and includes an outer soft region and an inner hard region.

22. A brake system according to claim 19, wherein the hydro-bearing comprises a ring-shaped hollow body, having a fluid therein.

23. A brake system according to claim 22, wherein the fluid within the hydro-bearing comprises has a variable viscosity controlled by a control device.

24. A brake system according to claim 23, wherein the second bearing device comprises a second bearing pin and a second accommodation, one of which is supported on the brake bracket and the other one is supported on the brake caliper, and wherein the second bearing pin is at least partially accommodated in the second accommodation.

25. A brake system according to claim 24, wherein the first and the second accommodations have the same inner configuration.

26. The brake system according to claim 15, wherein the damping element includes a ring-shaped body.

27. The brake system according to claim 15, wherein the damping element has at least a select one of a non-constant spring and non-constant damper characteristic.

28. The brake system according to claim 15, wherein the damping element comprises an elastomer bearing including an elastomer core having a Shore A hardness of about 35 to about 90.

29. A brake system according to claim 19 or 20, wherein the damping element comprises an elastomer bearing that includes multiple layers, and includes an outer soft region and an inner hard region.

30. A brake system according to claim 15, wherein the hydro-bearing comprises a ring-shaped hollow body, having a fluid therein.

31. A brake system according to claim 30, wherein the fluid within the hydro-bearing comprises has a variable viscosity controlled by a control device.

32. A brake system according to claim 15, wherein the second bearing device comprises a second bearing pin and a second accommodation, one of which is supported on the brake bracket and the other one is supported on the brake caliper, and wherein the second bearing pin is at least partially accommodated in the second accommodation.

33. A brake system according to claim 32, wherein the first and the second accommodations have the same inner configuration.
